(19) United States
(12) Patent Application Publication
(10) Pub. No.: US 2013/0126511 A1
(43) Pub. Date: May 23, 2013

(54) Disposable Multilayered Sleeveless Heated Vest

(71) Applicant: Mark Christopher Yulee, Tampa, FL (US)

(72) Inventor: Mark Christopher Yulee, Tampa, FL (US)

(21) Appl. No.: 13/680,324

(22) Filed: Nov. 19, 2012

Related U.S. Application Data
(60) Provisional application No. 61/562,038, filed on Nov. 21, 2011.

(51) Int. Cl. A41D 1/04; H05B 1/00

(52) U.S. Cl. CPC A41D 1/04; H05B 1/00
USPC 219/211

(57) ABSTRACT

A disposable multilayer sleeveless heated vest contains an integrated heated element which does not require an electrical power source or secondary heat sources to initially function and can be disposed of after use. The present invention comprises a front and rear section, a plurality of lateral fasteners, and a plurality of heat source compartments. Both the front and rear sections comprises an inner layer and an outer layer. The inner layer is insulated and moisture absorbent while the outer layer is moisture resistant. The plurality of lateral fasteners detachably couple the front and rear sections to a user's torso. The plurality of heat source compartments are positioned on both the front and rear sections and house the air activated heat source elements. The heat source elements provide heat to the user's torso until deactivating or removed by the user, at which point the user discards the vest.

The current application claims a priority to the U.S. Provisional Patent application Ser. No. 61/562,038 filed on Nov. 21, 2011.

### FIELD OF THE INVENTION

The present invention relates generally to a heated garment, more particularly to a disposable heated multilayered vest used as supplementary heat source for cold climate activities.

### BACKGROUND OF THE INVENTION

Currently available heated garment are able to provide users with the ability to regulate and maintain their core body temperature in cold climates. Most heated garments accomplish this through the use of a heated element and article of clothing contain compartments for the heat element. Generally the heated element is provided as an electrically powered component or as a dissipating heated element. Typically, the article of clothing is typically provided as a reusable insulated multilayered article of clothing constructed of a fabric material. While both of these components provide adequate functionality to the currently available heated garment they do suffer from a few drawbacks.

The currently available heated garments are provided with heated elements that require an electrical power source or an external heat source before they are able to function. The electrically powered heat sources require a user to utilize a battery or be tethered to a power source in order to actively provide heat to the user. The external heat source requiring variations do not require an electrical source but require the heated element to be heated to a specific temperature prior to use. While these heated elements provide the user with the ability to recharge and reuse their heat sources, both require additional components to initially function. This is a significant disadvantage for any unplanned or unanticipated outing that does not provide or include readily available power sources or methods to active the heating element. Another disadvantage is due in part to the construction of the insulated multilayer article of clothing. While their construction is useful in most situations, their construction carries a higher cost to manufacture as well as purchase, resulting in users limiting the use of the garment in situations which could potentially damage or soil the article of clothing.

It is therefore the object of the present invention to provide a disposable multilayered heated vest that contains an integrated heated element which does not require an electrical power source or secondary heat sources to initially function. The present invention additionally provides users with a material construction that would allow the heated vest to be disposed of after use. A further object of the present invention is to provide a means to prevent moisture from entering the space between the invention and the user's torso, while providing a moisture absorbing medium to deal with sweat.

### BRIEF DESCRIPTIONS OF THE DRAWINGS

FIG. 1 is a front perspective view of the current embodiment of the present invention displaying the front section, the collar opening, the pair of armholes, the plurality of lateral fasteners, and the plurality of heat source compartments.

FIG. 2 is a rear perspective view of the current embodiment of the present invention displaying the rear section, the collar opening, the pair of armholes, the plurality of lateral fasteners, and the plurality of heat source compartments.

FIG. 3 is a cross sectional perspective view of the current embodiment of the present invention displaying the inner layer and the outer layer in relation to the front section, the collar opening, the pair of armholes, the plurality of lateral fasteners, and the plurality of heat source compartments.

FIG. 4 is front perspective view of the current embodiment of the present invention being worn by a user.

FIG. 5 is a rear perspective view of the current embodiment of the present invention being worn by a user.

### DETAIL DESCRIPTIONS OF THE INVENTION

All illustrations of the drawings are for the purpose of describing selected versions of the present invention and are not intended to limit the scope of the present invention.

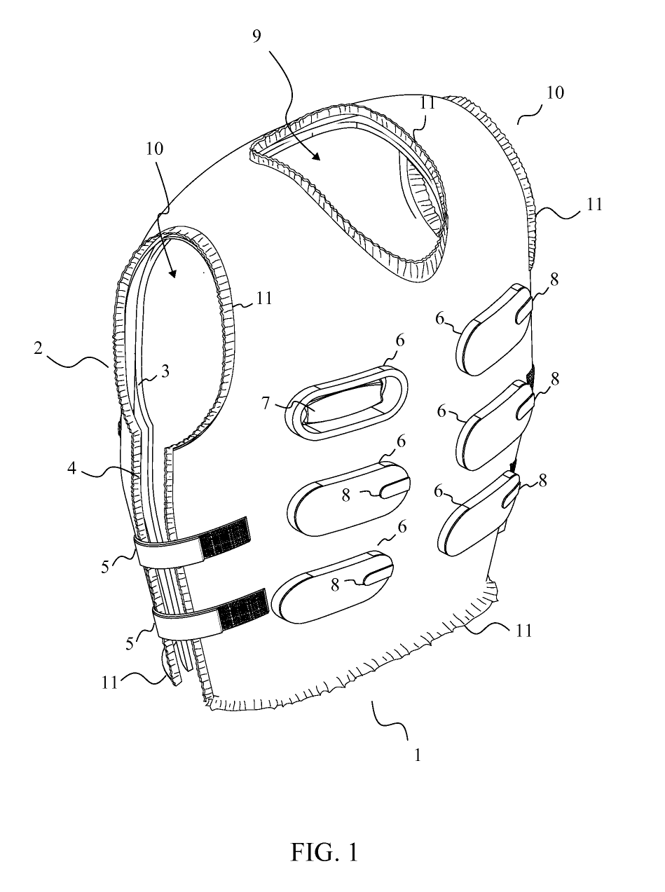

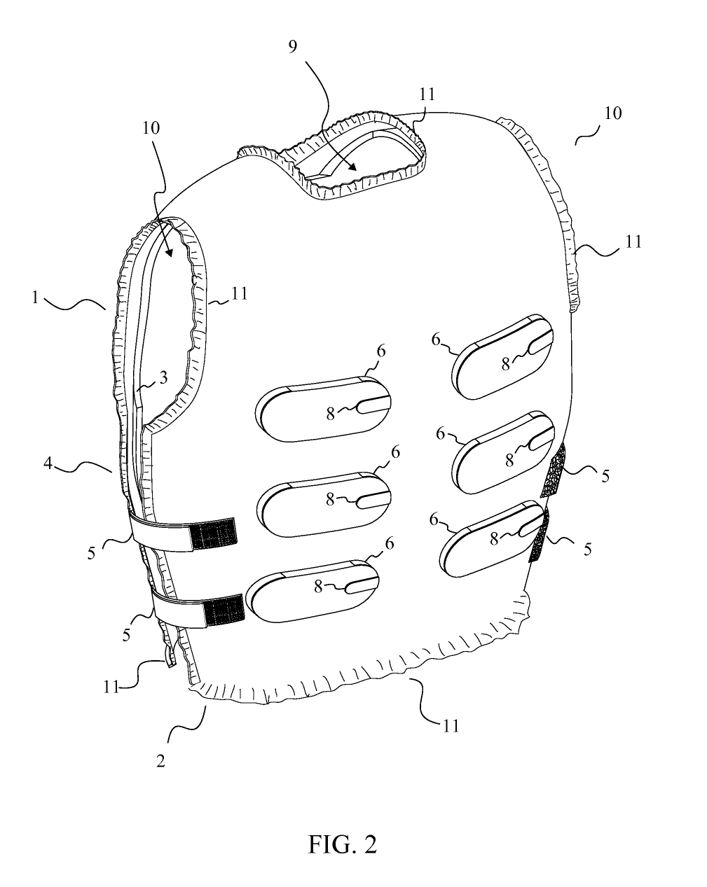

Referencing FIG. 1 and FIG. 2, the present invention is a disposable heated vest for use as a supplementary heat source for cold climate activities that repels unwanted ambient moisture while absorbing and deodorizing moisture due to perspiration. The garment accomplishes this through the use of a multilayered construction that separates moisture transmission between exterior and interior spaces while providing even heat distribution to a user's torso. The present invention comprises a front section 1, a rear section 2, a collar opening 9, and a pair of armholes 10. The user would wear the garment, in similar manner to a traditional vest, wherein the user would cover the anterior and posterior portions of their torso while leaving their arms exposed. The front section 1 of the present invention is the anterior portion of the garment that is in contact with the user's chest and abdomen. The rear section 2 of the present invention is the posterior portion of the garment that is in contact with the shoulders, shoulder blades, and lowers back. The collar opening 9 is the gap between the front section 1 and the rear section 2 which rests against the user's collar. The pair of armholes 10 is the openings through which the user traverses their arms. The

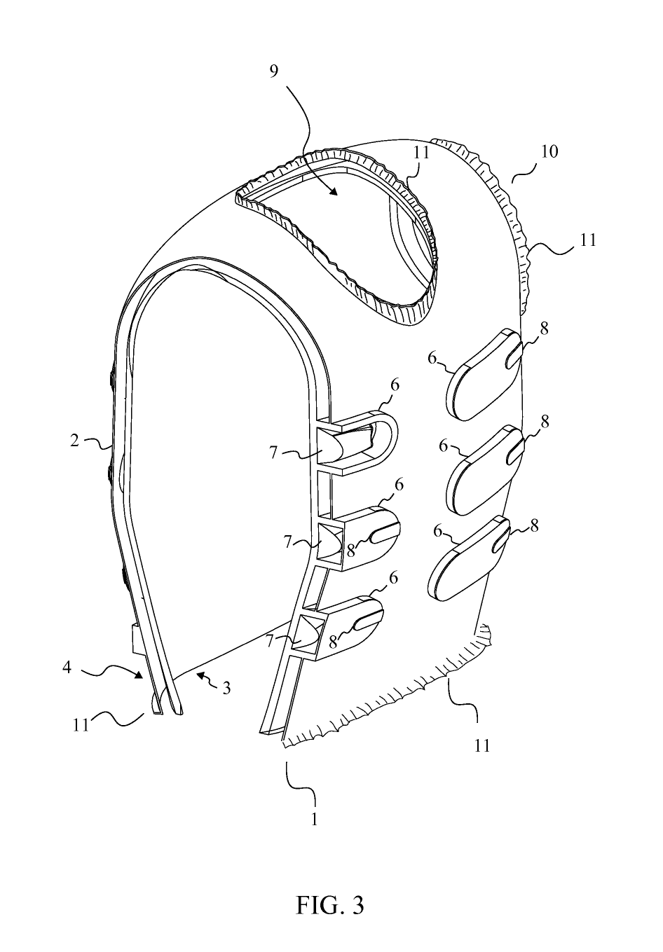

Referencing FIG. 3, both the front section 1 and the rear section 2 comprise an inner layer 3, an outer layer 4, a plurality of lateral fasteners 5, and a plurality of heat source compartments 6. The inner layer 3 is the portion of the present invention that is in interior portion of the present invention that is in contact with the user's torso. The outer layer 4 is super imposed onto the inner layer 3. The inner layer 3 is constructed of an insulating and moisture absorbent material that prevents dissipation of heat but reduces moisture due to perspiration through its absorbent construction material. Additionally, the insulating and moisture absorbent material contains antiperspirant and deodorizing agents in order to reduce moisture due to perspiration, while preventing unwanted odors. The outer layer 4 is the exterior surface for the front section 1 and the rear section 2. The outer layer 4 comprises a moisture resistant exterior surface that functions as a barrier that prevents unwanted moisture from reaching the interior portion of the garment as well as the inner layer 3.

Referencing FIG. 1 and FIG. 2, both the front section 1 and the rear section 2 comprise an elastic element 11. The elastic element 11 is positioned below the plurality of lateral fasteners 5 and is used to provide a moisture resistant sealed contact point between the user's waist or lower torso and the front section 1 and the rear section 2. The elastic element 11 of both the front section 1 and the rear section 3 allows the present invention to form a moisture resistant barrier while providing sufficient range of motion in a plurality of outdoor activities.

Referencing FIGS. 1-3, both the collar opening 9 and the pair of armholes 10 are found positioned coincident with the front section 1 and the rear section 2. The collar opening 9 is positioned between the front section 1 and the rear section 2 and is found positioned centrally on the upper portion of the garment. The collar opening 9 traverse through the outer layer 4 and the inner layer 3. Each armhole of the pair of armholes 10 being laterally positioned between the front section 1 and the rear section 2, wherein in an armhole of the pair of armholes 10 is found on the right side while the other armhole of the pair of armholes 10 is found on the left side. The positioning of the pair of armholes 10 results in bilateral symmetry.

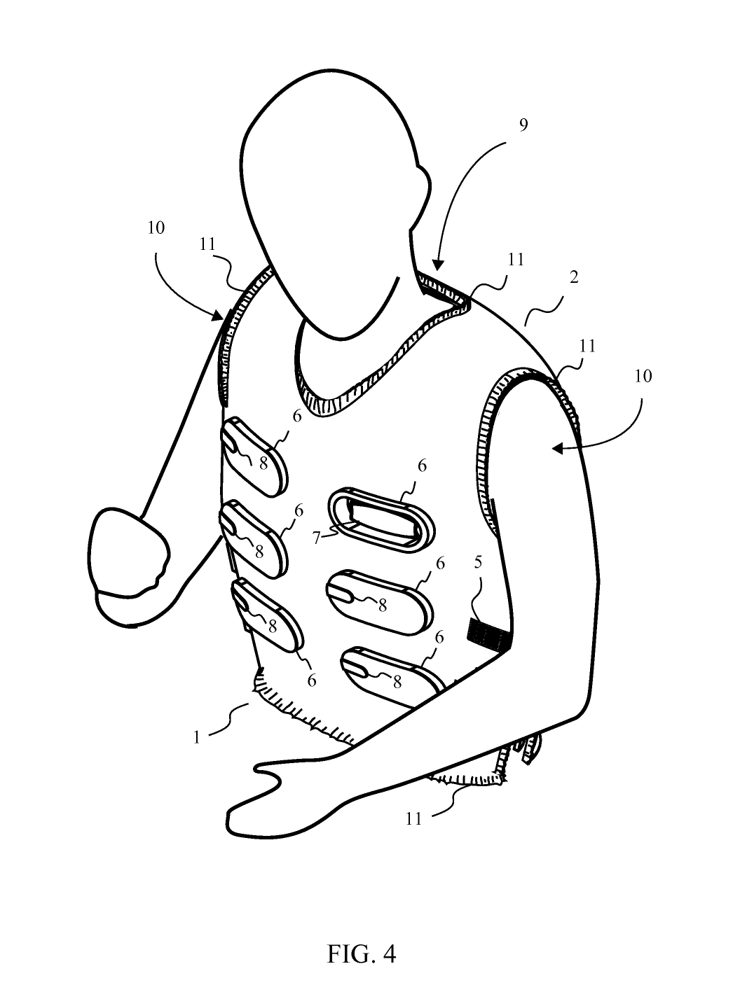

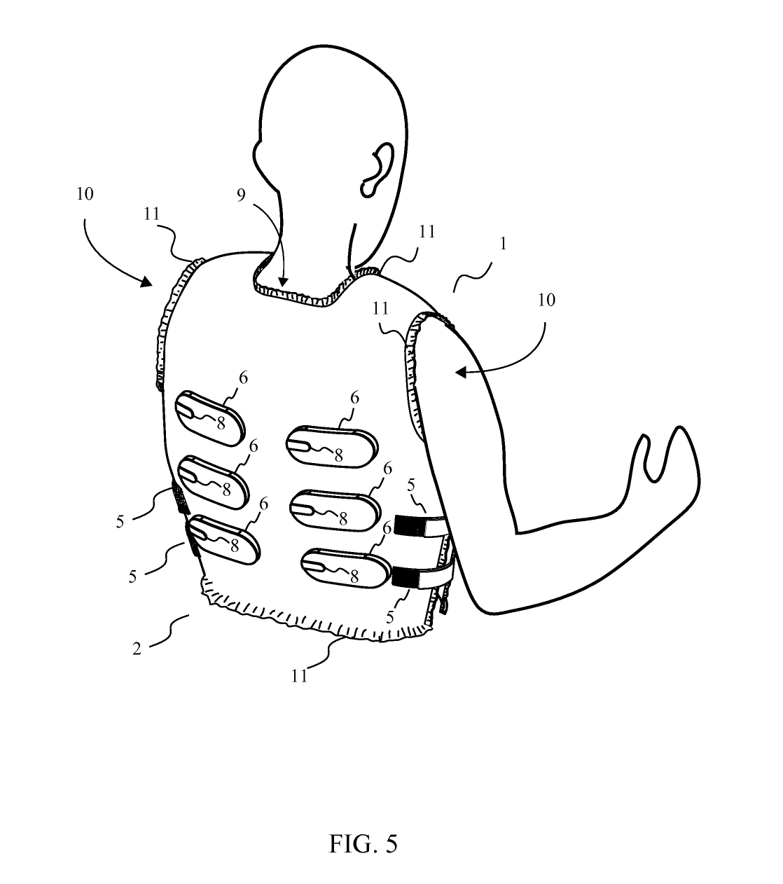

Referencing FIG. 4 and FIG. 5, both the collar opening 9 and the pair of armholes 10 comprise an elastic element. The elastic element is a flexible material that secures the collar opening 9 and the pair of armholes 10 from becoming susceptible to unwanted ambient moisture. The elastic element of the collar opening 9 is positioned against the surfaces of the front section 1 and the rear section 2 that are in contact with the collar opening 9. The elastic element of the collar opening 9 prevents moisture from entering into the inner layer 3 of the garment. The elastic element of the collar opening 9 rest on the edge of the outer layer 4 and the inner layer 3 and is the interaction point between the user's neck and the present invention. Similarly, the elastic element of the pair of armholes 10 is found positioned against the front section 1 and the rear section 2. The elastic element of the pair of armholes 10 functions as the point of contact between the user's arms and the present invention. The elastic element of the pair of armholes 10 prevents unwanted moisture from entering the inner layer 3 through the pair of armholes 10.

Referencing FIG. 1 and FIG. 2, both the front section 1 and the rear section 2 comprise a plurality of lateral fasteners 5. The plurality of lateral fasteners 5 serves as the means to securely couple the front section 1 and the rear section 2 the user's torso. The plurality of lateral fasteners 5 is adjustable and provides the front section 1 and the rear section 2 with a means to detachably couple to one another. The plurality of lateral fasteners 5 comprises a plurality of right lateral fastener and a plurality of left lateral fasteners 5. The plurality of right lateral fasteners 5 provide the right side portion of the front section 1 and the right side portion of the rear section 2 a means to fasten to one another. The plurality of left lateral fasteners 5 provides the left side portion of the front section 1 and the left side portion of the rear section 2 a means to fasten to one another.

Referencing FIG. 3, both the front section 1 and the rear section 2 comprise a plurality of heat source compartments 6. The heat source compartments 6 of the plurality of heat source compartments 6 are symmetrically arranged on the front section 1 and the rear section 2 in order to distribute heat evenly to a user's torso. The plurality of heat source compartments 6 each traverse into the inner layer 3 by traversing through the outer layer 4. The plurality of heat source compartments 6 each comprises a heat source element 7 and an air permeable cover 8. The heat source element 7 is an air activated thermal pack that produces heat through an exothermic oxidation reduction reaction occurring between an iron powder and ambient oxygen. The heat source element 7 is housed within the heat source compartment by way of an air permeable cover 8. The air permeable cover 8 provides oxygen to the heat source element 7 but prevent moisture from entering the heat source compartment. The air permeable cover 8 is removably coupled to the heat source compartment allowing facilitated access the heat source element 7 if necessary. The removable coupling of the air permeable cover 8 provides the present invention with a safety feature that allows a user to remove a particular heat source element 7 from the plurality of heat source compartments 6 from either the front section 1 or the rear section 2 without having to completely remove the garment.

The present invention is provided in an air tight packaging to prevent the air activated heat source from unintentionally reacting prior to use. To activate the present invention, the user would remove the disposable heated vest from the air tight packaging. Upon removal, the ferrous based heat source element 7 within the plurality of heat source compartments 6 would react with ambient oxygen made available through the air permeable cover 8. The user would don the vest securing the elastic element of the collar opening 9 around their neck. The user would additionally secure elastic element of the pair of armholes 10 around each of their arms. With the collar opening 9 and the pair of armholes 10 secured to their body the user would secure the front section 1 to the rear section 2 through the use of plurality of lateral fasteners 5. The user would secure the right side portion of the front section 1 to the right side portion of the rear section 2 by using the plurality of right lateral fasteners 5. The user would then secure the left side portion of the front section 1 to the left side portion of the rear section 2 by using the plurality of left lateral fasteners 5. The present invention is intended to provide consistent temperatures of up to 135° F. for a period of up to 8 hours. It should be noted that while the current embodiment of the present invention is able to provide heat for a period of up to 8 hours that it would be considered an obvious difference to include variations to the heat source element 7 that allow it to heat for a period of time greater than or equal to 8 hours. To deactivate the present invention the user would uncouple the plurality of right side fastener and the plurality of left side fasteners the user would remove the heat source element 7 from the plurality of heat source compartments 6 if still actively producing heat. After which the user would be able to safely discard the vest in any trash receptacle.

In the present invention the heat source element 7 is an air activated ferrous based heat pack. The air activated ferrous based heat pack utilized by the present invention is similar to currently available ferrous based heat packs which primarily consist of an iron powder, water, catalyst salt, activated carbon, and vermiculite. It should be noted that variations and substitution to currently available construction of the present invention is possible as long as the variations are able to provide the same or better functionality currently utilized by the present invention. The iron powder is the main reagent that produces heat by being oxidized when exposed to ambient oxygen. Water and salt are provided as catalysts that facilitate the oxidation of the iron powder. The activated carbon, commonly known as activated charcoal, serves two functions, it increase the speed of the oxidation and reduces odor produced by the reaction. The vermiculite serves as a reservoir for water. Although, the present invention utilizes the a ferrous based air activated heat source element 7 in its preferred embodiment, additional embodiment could potentially utilizes any air activated heat source element 7 that could safely and effectively achieve the same functionality currently exhibited by ferrous based air activated heat source elements 7.

In the present invention the inner layer 3 is constructed of an insulating and moisture absorbent material. The insulating and moisture absorbent material comprises of an absorbent paper construction made from a plurality of materials that can include cellulose pulp, wood pulp, cotton as well as any combination thereof. The present invention additionally includes absorbent compounds that work to increase the absorbency of the absorbent paper construction. The absorbent compounds utilized by the present invention include but are not limited to sodium acrylate, postassium acrylate, alkylacrylate as well as any combination thereof. Furthermore, the absorbent paper construction includes antiperspirant and deodorant agents to help reduce moisture generated by the user during their activities. The antiperspirant and deodorizing agents can include but are not limited to Aluminium chloride, aluminium chlorohydrate, and aluminium-zirconium compounds, aluminium zirconium tetrachlorohydrex gly and aluminium zirconium trichlorohydro as well as any combination thereof.

In the present invention the outer layer 4 comprises a moisture resistant exterior surface. The moisture resistant exterior surface is provided by a polyethylene coated paper construction that is able to repel moisture while maintaining a sturdy construction through rigorous activities. While the present invention utilizes a polyethylene coated paper construction to provide the moisture resistant exterior surface, additional embodiments could potentially utilizes a plurality of flexible moisture resistant coating that would be able to provide the same or better functionality than the currently utilized polyethylene coated paper construction. Furthermore, in additional embodiment the outer layer 4 may be constructed of a non paper material capable of accomplishing the same current functionality as the polyethylene coated paper material. Moreover, the polyethylene coated paper construction of the present invention can additionally include a thin coating of a primer polymer which would allow the present invention to include a plurality of printed designs such as patterns or logos.

In the present invention the plurality of lateral fasteners 5 are utilized to secure the front section 1 to the rear section 2. In the current embodiment of the present invention the plurality of lateral fasteners 5 consist of a Velcro and/or an adhesive fastener. It should be noted that the adhesive fasteners utilized by the present invention should allow a user to detachably couple the front section 1 to the rear section 2 and that the fasteners could potentially be utilized together to provide a more specialized connection method, depending on positioning or angle of attachment. Furthermore, it should be noted that the adhesive fasteners of the present invention are most similar to the adhesive fasteners utilized by diapers, and share similar durability and moisture resistant properties. Although, the present invention utilizes the a plurality of Velcro strap and/or a plurality of adhesive fasteners as the means to securely fasten the front section 1 and the rear section 2 of the vest, additional fastener types could potentially be used as long as they provide the present invention with a means to quickly secure the invention to the person's body, as well as to provide a means of removal if necessary.

In the current embodiment of the present invention the plurality of lateral fasteners 5 are further described as being on right and left sides of the vest. While this is the current embodiment it should be noted that the lateral fasteners 5 provide a single lateral opening. The single lateral opening could be on either the right or left side of the front section 1 and the rear section 2. The user would be able do the vest similar to a poncho. Furthermore, while the present invention has the plurality of lateral fasteners 5 located on the sides of the vest it should be noted that additional embodiment could potentially have a plurality of fasteners arranged in a plurality of means that can include a central positioning as well as an asymmetric. Although this configuration changes the manner in which the front section 1 and the rear section 2 interact it should be noted that the positioning of the plurality of fasteners would not change the function of securing the present invention to the user's torso. Moreover, it should be noted that while the location of the plurality of lateral fasteners 5 relative to the positioning of the outer layer 4 and the inner layer 3 is not specified, it would be understood as an obvious difference to specify the positioning due in part to the front section 1 and the rear section 2 both comprising an inner layer 3 and an outer layer 4.

In the current embodiment the elastic element used to securely fasten the collar opening 9 and the pair of armholes 10 to the user's neck and arms, respectively, comprises an elastic band that is flexible enough to securely fasten around the neck and arms of users of various sizes.

In the current embodiment of the present invention the plurality of heat source compartments 6 are arranged in a symmetrical arrangement that is able to provide the user with an even distribution of heat to the front section 1 and the rear section 2. While the arrangement of the plurality of heat source compartment is symmetrical, additional embodiments can be configured to include asymmetrical arrangements as well as particular arrangements if needed.

Although the invention has been explained in relation to its preferred embodiment, it is to be understood that many other possible modifications and variations can be made without departing from the spirit and scope of the invention as hereinafter claimed.

What is claimed is:

1. A disposable multilayered sleeveless heated vest comprises:
a front section,
a rear section,
a collar opening;
a pair of armholes;
the collar opening, the pair of armholes, the front section, and the rear section each comprise an elastic element;
both the front section and the rear section comprise an inner layer, an outer layer, a plurality of lateral fasteners, and a plurality of heat source compartments;
the plurality of heat source compartments comprises a heat source element and an air permeable cover;
the inner layer being constructed of an insulating and moisture absorbent material;
the insulating and moisture absorbent material contains antiperspirant and deodorizing agents; and
the outer layer comprises a moisture resistant exterior surface.

2. The disposable heated vest as claimed in claim 1 comprises:
the outer layer being superimposed over the inner layer, wherein the inner layer is proximal to a user's torso;
the collar opening traversing through the outer layer and the inner layer;
the collar opening being positioned between the front section and the rear section;
the pair of armholes being laterally positioned between the front section and the rear section, wherein each armhole of the pair of armholes are positioned across the superior-inferior axis achieving bi-lateral symmetry;
the front section and the rear section being detachably coupled; and
the plurality of heat source compartments being integrated into the front section and the rear section.

3. The disposable multilayered sleeveless heated vest as claimed in claim 1 comprises:
the plurality of heat source compartments traverse through the outer layer into the inner layer; and
the plurality of heat source compartments being symmetrically arranged on the front section and the rear section, wherein the plurality of heat source compartments are arranged in a particular manner that evenly distributes heat.

4. The disposable multilayered sleeveless heated vest as claimed in claim 1 comprises:
the elastic element of the collar opening being positioned against the front section and the rear section, wherein the elastic element of the collar opening is found integrated into the edge of the front section and the rear section in contact with the collar opening;
the elastic element of the pair of armholes being positioned against the front section and the rear section, wherein the elastic element of the pair of armholes is found integrated into the edge of the front section and the rear section in contact with each of the pair of armholes; and
the elastic element of the front section and the rear section being positioned below the plurality of lateral fasteners, wherein the elastic element of the front section and the rear section is positioned proximal to a user's waist.

5. The disposable multilayered sleeveless heated vest as claimed in claim 1 comprises:
the heat source element being enclosed within the plurality of heat source compartments by way of the air permeable cover; and
the front section and the rear section being detachably coupled by way of the plurality of lateral fasteners.

6. The disposable multilayered sleeveless heated vest in claim 5, wherein the plurality of lateral fasteners comprises a plurality of right lateral fasteners and a plurality of left lateral fasteners.

7. The disposable multilayered sleeveless heated vest as claimed in claim 5 comprises:
the air permeable cover being removably coupled to the plurality of heat source compartments, wherein the detachment of the air permeable cover provides access to the heat source element allowing facilitated removal if necessary.

8. The disposable multilayered sleeveless heated vest as claimed in claim 5 comprises:
the heat source element comprises an air activated heat warmer, wherein the air activated heat warmer produces heat through the exothermic oxidization of a ferrous salt.

9. A disposable multilayered sleeveless heated vest comprises:
a front section,
a rear section,
a collar opening;
a pair of armholes;
the collar opening, the pair of armholes, the front section, and the rear section each comprise an elastic element;
both the front section and the rear section comprise an inner layer, an outer layer, a plurality of lateral fasteners, and a plurality of heat source compartments;
the plurality of heat source compartments comprises a heat source element and an air permeable cover;
the inner layer being constructed of an insulating and moisture absorbent material;
the insulating and moisture absorbent material contains antiperspirant and deodorizing agents; and
the outer layer comprises a moisture resistant exterior surface.

10. The disposable multilayered sleeveless heated vest as claimed in claim 9 comprises:
The outer layer being superimposed over the inner layer, wherein the inner layer is proximal to a user's torso;
The collar opening traversing through the outer layer and the inner layer;
the collar opening being positioned between the front section and the rear section;
the pair of armholes being laterally positioned between the front section and the rear section, wherein each armhole of the pair of armholes are positioned across the superior-inferior axis achieving bi-lateral symmetry;
the front section and the rear section being detachably coupled; and
the plurality of heat source compartments being integrated into the front section and the rear section.

11. The disposable multilayered sleeveless heated vest as claimed in claim 9 comprises:
the plurality of heat source compartments traverse through the outer layer into the inner layer; and
the plurality of heat source compartments being symmetrically arranged on the front section and the rear section, wherein the plurality of heat source compartments are arranged in a particular manner that evenly distributes heat.

12. The disposable multilayered sleeveless heated vest as claimed in claim 9 comprises:
the elastic element of the collar opening being positioned against the front section and the rear section, wherein the elastic element of the collar opening is found integrated into the edge of the front section and the rear section in contact with the collar opening;
the elastic element of the pair of armholes being positioned against the front section and the rear section, wherein the elastic element of the pair of armholes is found integrated into the edge of the front section and the rear section in contact with each of the pair of armholes; and
the elastic element of the front section and the rear section being positioned below the plurality of lateral fasteners, wherein the elastic element of the front section and the rear section is positioned proximal to a user's waist.

13. The disposable multilayered sleeveless heated vest as claimed in claim 9 comprises:
the heat source element being enclosed within the plurality of heat source compartments by way of the air permeable cover; and
the front section and the rear section being detachably coupled by way of the plurality of lateral fasteners.

14. The disposable multilayered sleeveless heated vest in claim 13, wherein the plurality of lateral fasteners comprises a plurality of right lateral fasteners and a plurality of left lateral fasteners.

15. The disposable multilayered sleeveless heated vest as claimed in claim 13 comprises:
the air permeable cover being removably coupled to the plurality of heat source compartments, wherein the detachment of the air permeable cover provides access to the heat source element allowing facilitated removal if necessary; and
the heat source element comprises an air activated heat warmer, wherein the air activated heat warmer produces heat through the exothermic oxidization of a ferrous salt.

16. A disposable multilayered sleeveless heated vest comprises:
a front section,
a rear section,
a collar opening;
a pair of armholes;
the collar opening, the pair of armholes, the front section, and the rear section each comprise an elastic element;
both the front section and the rear section comprise an inner layer, an outer layer, a plurality of lateral fasteners, and a plurality of heat source compartments;
the plurality of heat source compartments comprises a heat source element and an air permeable cover;
the inner layer being constructed of an insulating and moisture absorbent material;
the insulating and moisture absorbent material contains antiperspirant and deodorizing agents;
the outer layer comprises a moisture resistant exterior surface;
The outer layer being superimposed over the inner layer, wherein the inner layer is proximal to a user's torso;
The collar opening traversing through the outer layer and the inner layer;
the collar opening being positioned between the front section and the rear section;
the pair of armholes being laterally positioned between the front section and the rear section, wherein each armhole of the pair of armholes are positioned across the superior-inferior axis achieving bi-lateral symmetry;
the front section and the rear section being detachably coupled; and
the plurality of heat source compartments being integrated into the front section and the rear section.

17. The disposable multilayered sleeveless heated vest as claimed in claim 16 comprises:
the plurality of heat source compartments traverse through the outer layer into the inner layer; and
the plurality of heat source compartments being symmetrically arranged on the front section and the rear section, wherein the plurality of heat source compartments are arranged in a particular manner that evenly distributes heat.

18. The disposable multilayered sleeveless heated vest as claimed in claim 16 comprises:
the elastic element of the collar opening being positioned against the front section and the rear section, wherein the elastic element of the collar opening is found integrated into the edge of the front section and the rear section in contact with the collar opening;
the elastic element of the pair of armholes being positioned against the front section and the rear section, wherein the elastic element of the pair of armholes is found integrated into the edge of the front section and the rear section in contact with each of the pair of armholes; and
the elastic element of the front section and the rear section being positioned below the plurality of lateral fasteners, wherein the elastic element of the front section and the rear section is positioned proximal to a user's waist.

19. The disposable multilayered sleeveless heated vest as claimed in claim 16 comprises:
the heat source element being enclosed within the plurality of heat source compartments by way of the air permeable cover; and
the front section and the rear section being detachably coupled by way of the plurality of lateral fasteners.

20. The disposable multilayered sleeveless heated vest in claim 19,
wherein the plurality of lateral fasteners comprises a plurality of right lateral fasteners and a plurality of left lateral fasteners.
the air permeable cover being removably coupled to the plurality of heat source compartments, wherein the detachment of the air permeable cover provides access to the heat source element allowing facilitated removal if necessary; and
the heat source element comprises an air activated heat warmer, wherein the air activated heat warmer produces heat through the exothermic oxidization of a ferrous salt.
